(19) United States
(12) Patent Application Publication
(10) Pub. No.: US 2007/0061464 A1
(43) Pub. Date: Mar. 15, 2007

(54) System and method for providing differentiated service by using category/resource scheduling

(76) Inventors: Ruo-Hua Feng, Hsinchu (TW); Ying-Dar Lin, Hsinchu (TW); Ching-Ming Tien, Hsinchu (TW); Yuan-Cheng Lai, Hsinchu (TW); Tzuo-Chun Lee, Hsinchu (TW); Po-Wen Cheng, Hsinchu (TW); Shu-Fen Yang, Hsinchu (TW)

Correspondence Address: HARNESS, DICKEY & PIERCE, P.L.C., P.O. BOX 8910, RESTON, VA, 20195, US

(21) Appl. No.: 11/434,932

(22) Filed: May 17, 2006

Related U.S. Application Data
(63) Continuation-in-part of application No. 11/222,770, filed on Sep. 12, 2005.

(30) Foreign Application Priority Data
Dec. 28, 2005 (TW) 094146975

(51) Int. Cl. G06F 15/173

(52) U.S. Cl. 709/226

(57) ABSTRACT

A system for providing differentiated service by using category/resource scheduling and the method thereof are provided. The system and the method are mainly used in the Internet environment, and apply computer executable programs executed at relay points or in a servo system to schedule the processes of external requests according to classified categories of and resources consumed by the external requests when the servo system receives the external requests from the Internet. The time points when individual external requests are released to the servo system to be processed are determined by the category weight corresponding to each external request, the proportion of resource consumed by each external request, and the capacity of available resources in the servo system.

### CROSS-REFERENCE TO RELATED APPLICATIONS

This application is a continuation-in-part patent application of U.S. application Ser. No. 11/222,770 filed on Sep. 12 2005, the entire contents of which are hereby incorporated by reference for which priority is claimed under 35 U.S.C. § 120.

This non-provisional application claims priority under 35 U.S.C. § 119(a) on Patent Application No(s). 094146975 filed in Taiwan, R.O.C. on Dec. 28, 2005, the entire contents of which are hereby incorporated by reference.

### BACKGROUND OF THE INVENTION

1. Field of Invention

The present invention relates to a system and method applicable to the Internet for providing differentiated service by scheduling external requests. More particularly, the present invention relates to a system and method applicable to determine the scheduling and processing of external requests-according to the category weight of the external requests, the resources consumed by the external requests, and the available resources in the servo system.

2. Related Art

With the prosperous development of various applications in the Internet environment, the demand for servo systems is increasingly greater, which, together with the growth of the number of the Internet users, has made the average load of most servo systems become increasingly greater as well.

In fact, overload of a servo system often keeps users waiting a long time for the service, and even leads to a total paralysis of service of the servo system. Therefore, many servo systems tend to grant more servo system throughput to users of higher level by means of differentiated service, to differentiate service waiting times for users after external requests are sent. Thus, users of higher level will obtain better service quality, and the satisfaction level of these users will be improved.

Generally, there are two approaches applied to provide differentiated service in a servo system. One approach is classifying the external requests to be received by the servo system according to appropriate weights, i.e., providing different priority to different external requests, such that external requests sent by different users will obtain different servo system throughput, thereby differentiated service is realized. The other is that as every external request requires different resources of the servo system, and the consumption proportions of the different resources are also different from each other, if the servo system resources are effectively allocated and planned, differentiated service may also be achieved while maximizing the resource utilization of the servo system.

FIG. 1a and FIG. 1b are schematic views respectively showing the quality of differentiated service without using a servo system for providing differentiated service by using category/resource scheduling, and the quality of differentiated service using a servo system for providing differentiated service by using category scheduling.

For differentiated service quality 01 without category/resource scheduling shown in FIG. 1a, different external requests (Category A, Category B, and Category C) have the same overall resource utilization rate for the servo system, and have the same utilization rate for various resources (CPU resources, disk access resources, and transmission bandwidth resources) of the servo system, which results in the situation that there is totally no difference in service among users. On the other hand, for differentiated service quality 02 with category scheduling as shown in FIG. 1b, as the servo system classifies and schedules the external requests in a single resource, i.e. different external requests of Category A, Category B, and Category C are classified and scheduled in different proportions only in the CPU resource, but not in the disk access resource and the transmission bandwidth resource, therefore it can be seen from the drawing that though different external requests (Category A, Category B, and Category C) still have the same utilization rate for the overall resources of the servo system, as for the major resource of the servo system (the CPU resource), the utilization rate does have the feature of differentiated service, that is, the utilization rates of the respective Category A, Category B, and Category C for the CPU resource follow a planned proportion. Therefore, this situation enables the servo system to provide differentiated service in a certain degree. However, this situation still leads to one problem, that is, when external requests make large demands on the same resource of the servo system, the specific resource of the servo system will easily be used up, which might cause the waste or overload of other resources in the servo system, and thus will greatly influence the quality of differentiated service provided for users.

In U.S. Pat. No. 6,816,907, it utilizes a priority table in the main servo system to control the sequence of transmitting the external requests to the servo system, wherein the priority table classifies all external requests into at least two levels. There are two criteria to determine the transmission sequence: (1) when the number of external requests of the higher level is no less than a predetermined transmission number, the external requests of the higher level of the same number with the predetermined transmission number are transmitted to the servo system; (2) when the number of external requests of the higher level is less than a predetermined transmission number, a mixture of external requests of the higher level and the lower level is transmitted to the servo system, and the number of external requests being transmitted is the same with the predetermined transmission number. This mainly classifies the external requests into two categories according to different priorities, and by emphasizing that external requests of higher level must obtain a greater number of processes from the servo system than external requests of lower level, differentiated service is achieved. Though this approach ensures that the number of processed external requests differs according to level, it does not mean users of higher level will obtain better service quality, since all external requests do not consume the same resources of the servo system, i.e. the size of the responses for individual external requests differ from each other, so processing a greater number of external requests of higher level does not mean that the servo system provides more resources to the external requests of higher level, and users of higher level may not necessarily enjoy better service quality, that is, the service waiting time perceived by these users is not necessarily shortened.

Another prior art, U.S. Pat. No. 6,728,748, utilizes a routing host to receive all external requests and classifies the external requests, then communicates with the routing host and proxies disposed in various servo systems through the adaptive policy engine connected between the routing host and multiple servo systems, and determines which category of external requests should be assigned to which servo system to be processed according to the attribute information of various servo systems returned from the proxies.

Though various methods of differentiated service are provided in the conventional arts, they basically belong to the differentiated service mode generated from the classification of the categories of the external requests as described in FIG. 1b, therefore, when the servo system resources required by the external requests are extremely concentrated, problems of resource exhaustion or resource idling still exist.

Therefore, to provide better quality differentiated service, and to reduce the influence on the operation of the servo system caused by differentiated service, an integrated consideration of the aforementioned two factors has to be made: one is the priority of the external requests, and the other is the allocation of resources required by the external requests. Thereby, complete differentiated service can be provided.

### SUMMARY OF THE INVENTION

Accordingly, an object of the present invention is to provide a system for providing differentiated service by using category/resource scheduling and a method therefor.

In the present invention, through designating different category weights to different external requests, external requests from users will obtain different qualities of differentiated service, especially in that the administrator of the servo system may grant different proportions of utilization rate of the servo system resources to clients of different categories, and the proportions of the servo system resources used by various categories of clients are determined in accordance with the designated category weights, thus the effect that different users obtain significantly differentiated servo system throughput and response waiting time can be achieved.

In addition, in the present invention, through effectively allocating the consumed resources for various resources of the servo system, that is, through maximally improving the utilization rate of various resources of the servo system, the effect of the bottleneck caused by a single resource on the utilization rate of other resources can be reduced, thus the effect of reducing the influence on the quality of the differentiated service caused by resource exhaustion and resource idling can be achieved.

Furthermore, the present invention is realized mainly through computer executable programs, therefore, when the invention is applied in the Internet environment, it can optionally be executed at relay points of the Internet or on the servers including the servo system directly. When executed at relay points, the present invention good differentiated service quality may be easily achieved without any change to user-end applications or the servo systems. Compared with the prior art, the present invention can be easily realized with less resources invested.

The features and practices of the present invention are described in detail below with preferred embodiments accompanied with drawings. To facilitate a further understanding of the objects, structure, features, and functions of the present invention, preferred embodiments are described below in detail.

Further scope of applicability of the present invention will become apparent from the detailed description given hereinafter. However, it must be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1a is a schematic view showing the quality of differentiated service without applying a servo system for providing differentiated service by using category/resource scheduling according to a conventional technique.

FIG. 1b is a schematic view showing the quality of differentiated service applying a servo system for providing differentiated service by using category scheduling according to the conventional technique.

FIG. 1c is a schematic view showing the quality of differentiated service of the servo system for providing differentiated service by using category/resource scheduling according to the present invention.

FIG. 2 is a schematic and functional block diagram of the system operation of the system for providing differentiated service by using category/resource scheduling according to the present invention.

FIGS. 3a to 3f are main and detailed flow charts of the method for providing differentiated service by using category/resource scheduling according to the present invention.

FIGS. 4a to 4k are schematic views showing the embodiment of the system for providing differentiated service by using category/resource scheduling according to the present invention.

### DETAILED DESCRIPTION OF THE INVENTION

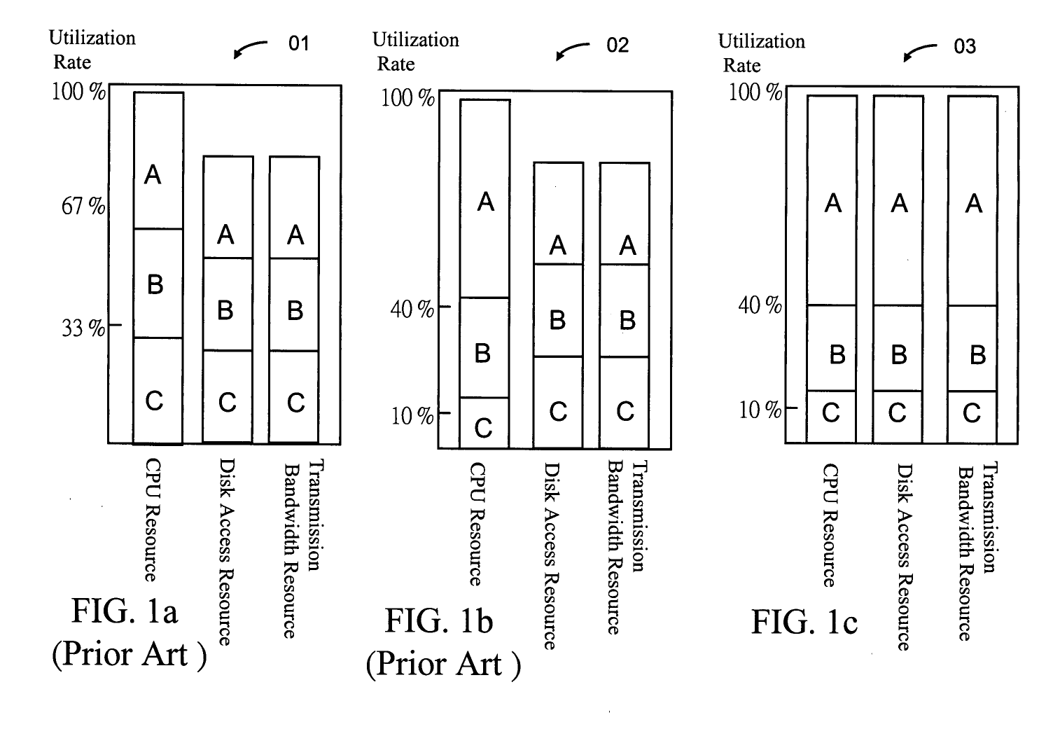

The present invention provides a system for providing differentiated service by using category/resource scheduling and a method therefor, which are applied to schedule the processes of external requests 50 according to the classified category of and the resource to be consumed by the external requests 50, when a servo system 150 is ready to receive the external requests 50 from the Internet 100. The time points when the external requests 50 are sent to the servo system 150 to be processed are determined by the assigned category weight of and the resource required by the external requests 50 and the capacity of available resources of the servo system. FIG. 1c shows the quality 03 of the differentiated service of the present invention using category/resource scheduling. As the external requests 50 are appropriately classified and scheduled, i.e. the proportion of various resources of the servo system used by Category A, Category B, and Category C depends on their category weight 6:3:1. And various resources, i.e. CPU resource, disk access resource, and transmission bandwidth resource, of the servo system 150 are appropriately allocated, thus it can be seen that the utilization rates of different categories (Category A, Category B, and Category C) for the overall resources of the external requests 50 are obviously differentiated, i.e. the utilization rates for various resources of the servo system obtained by Category A, Category B and Category C are 60%, 30%, and 10% respectively, and thus the external requests 50 have significantly differentiated service qualities, and the utilization rate for the resources of the servo system 150 is maximized.

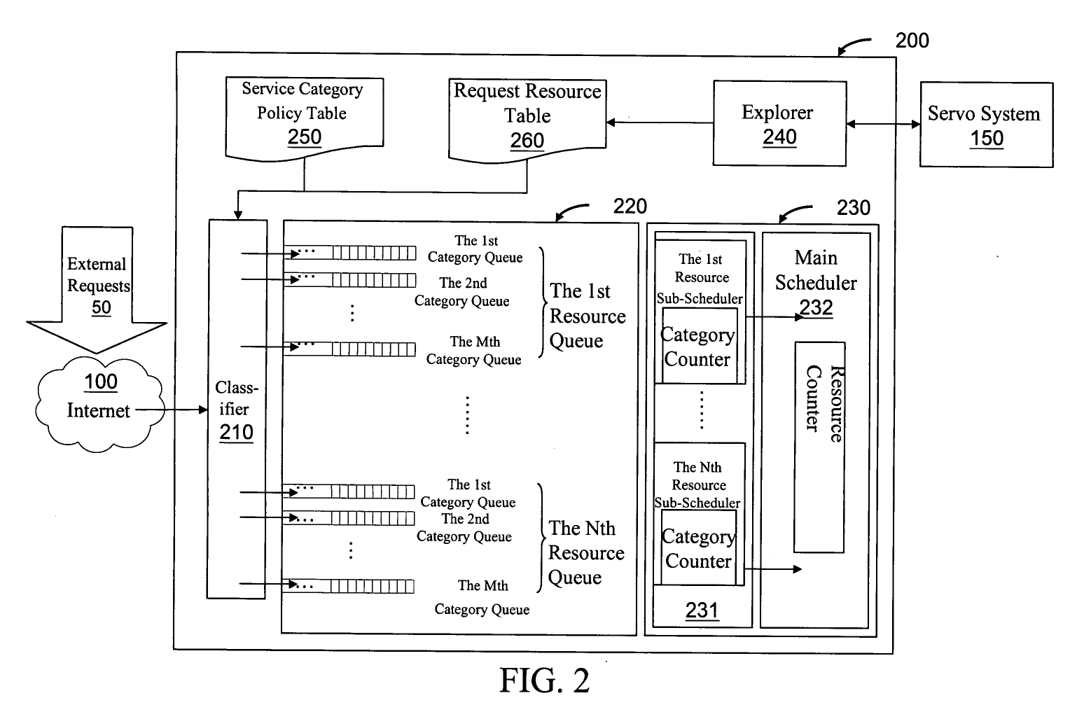

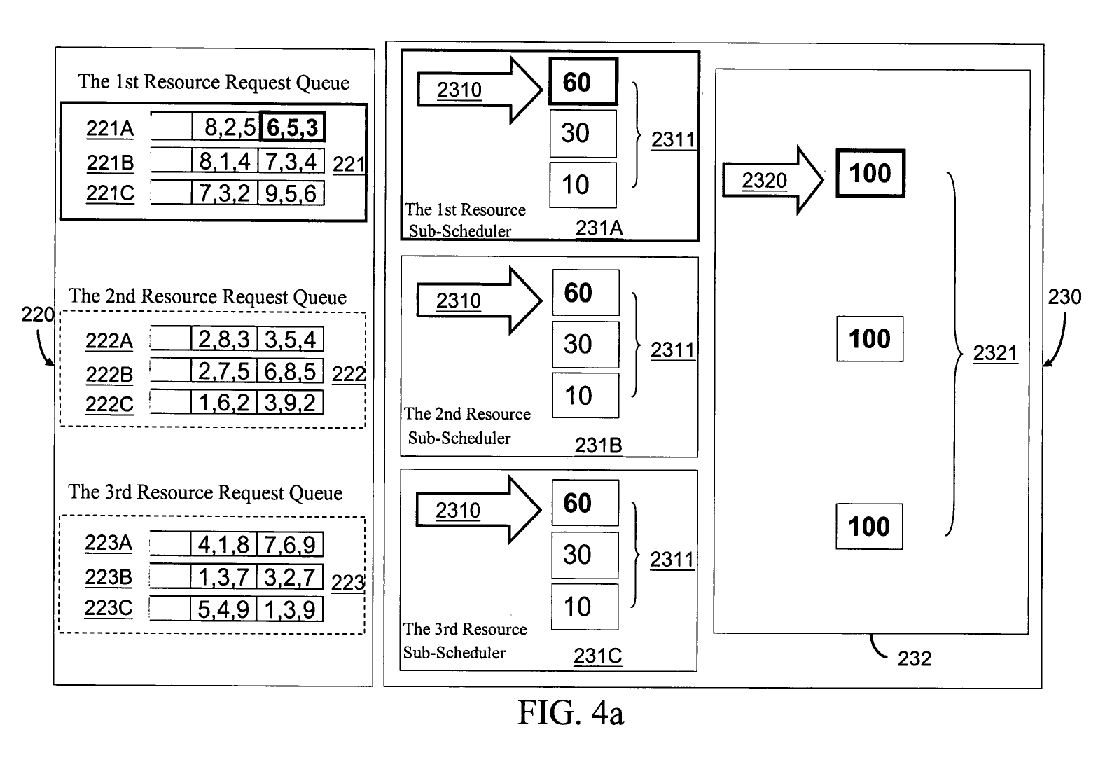

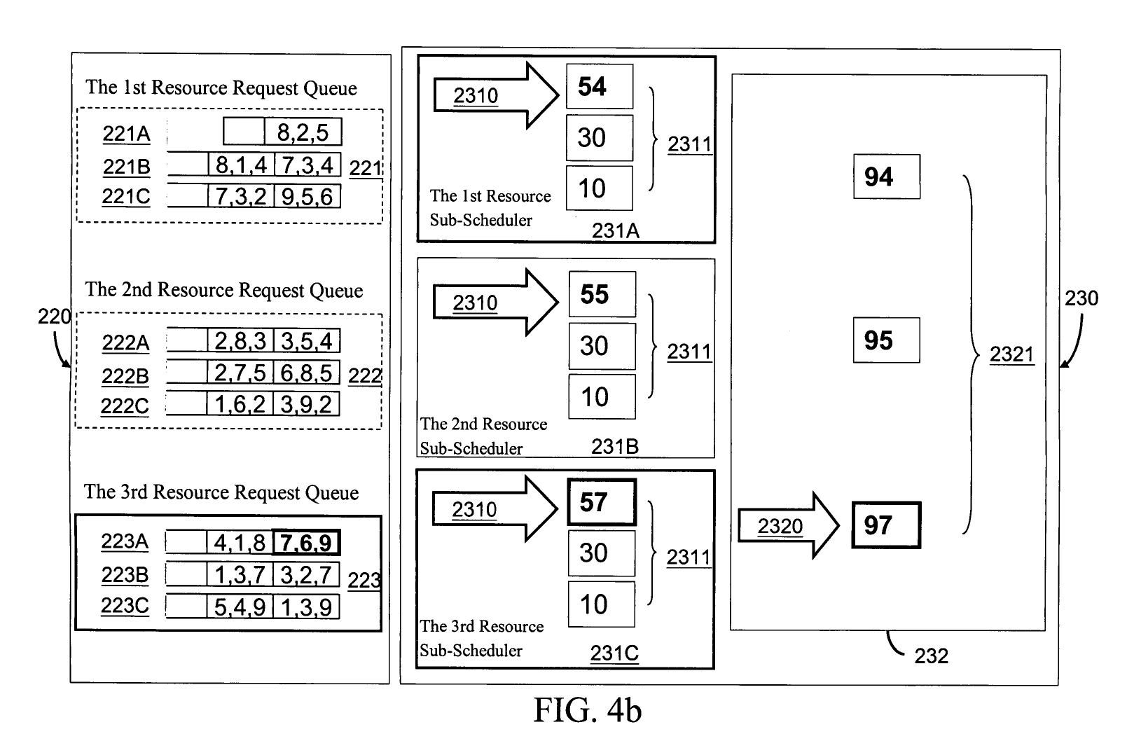

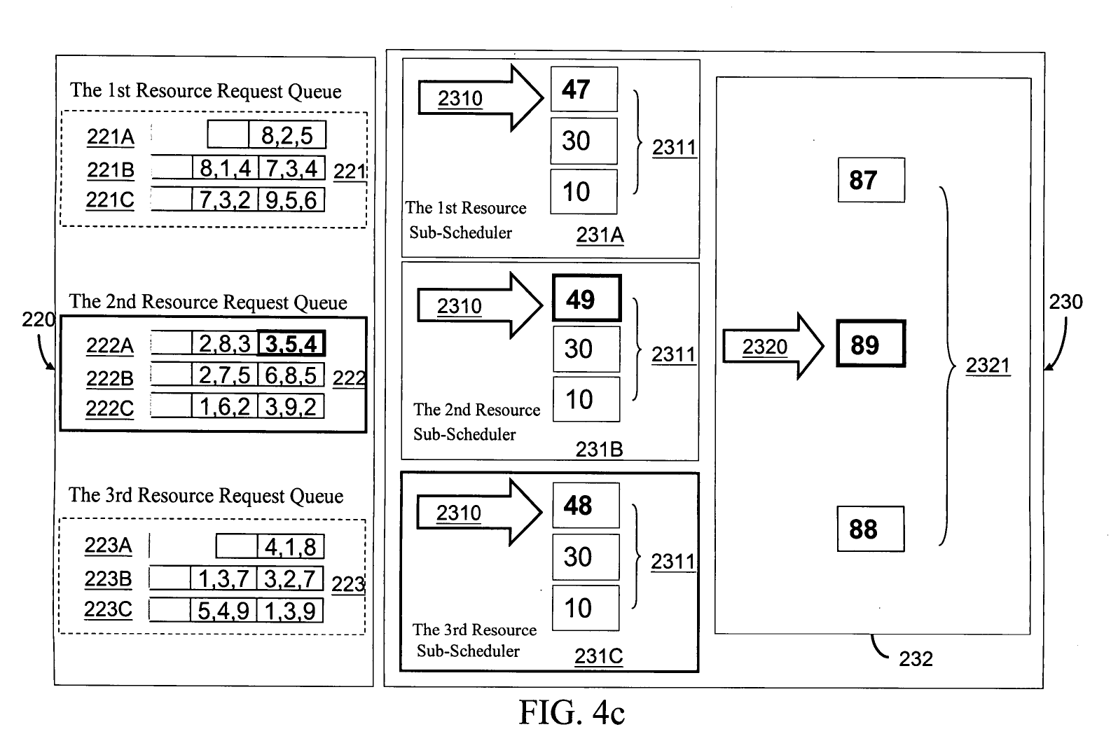

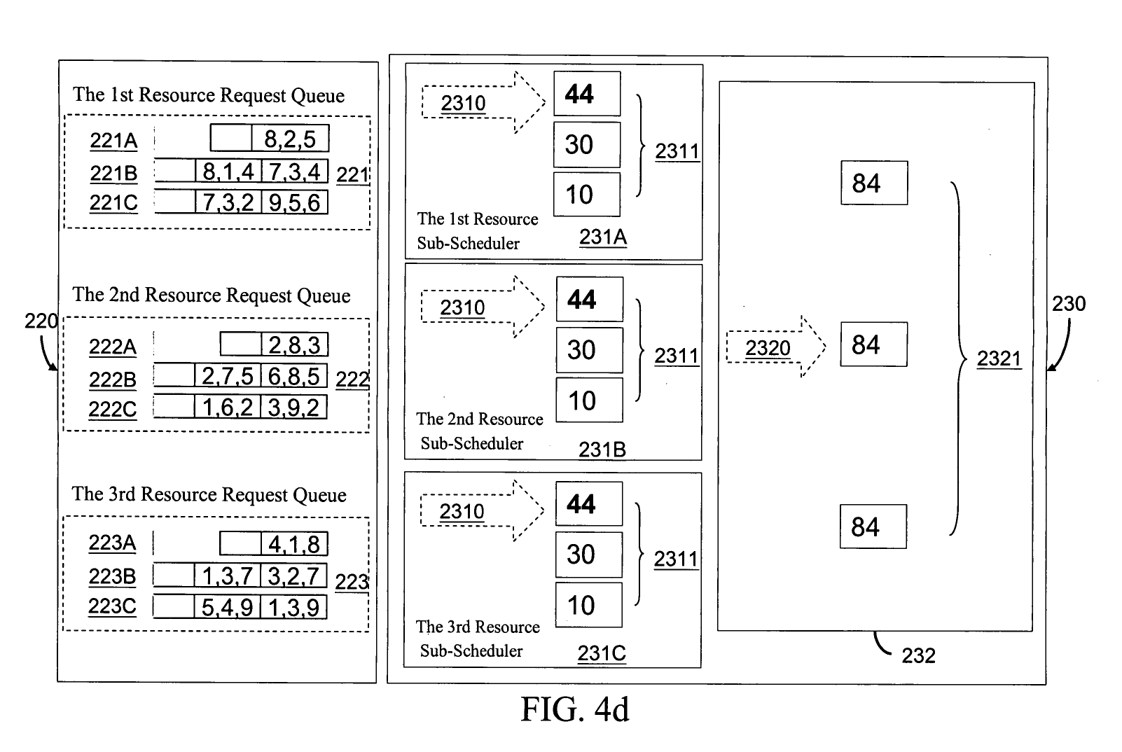

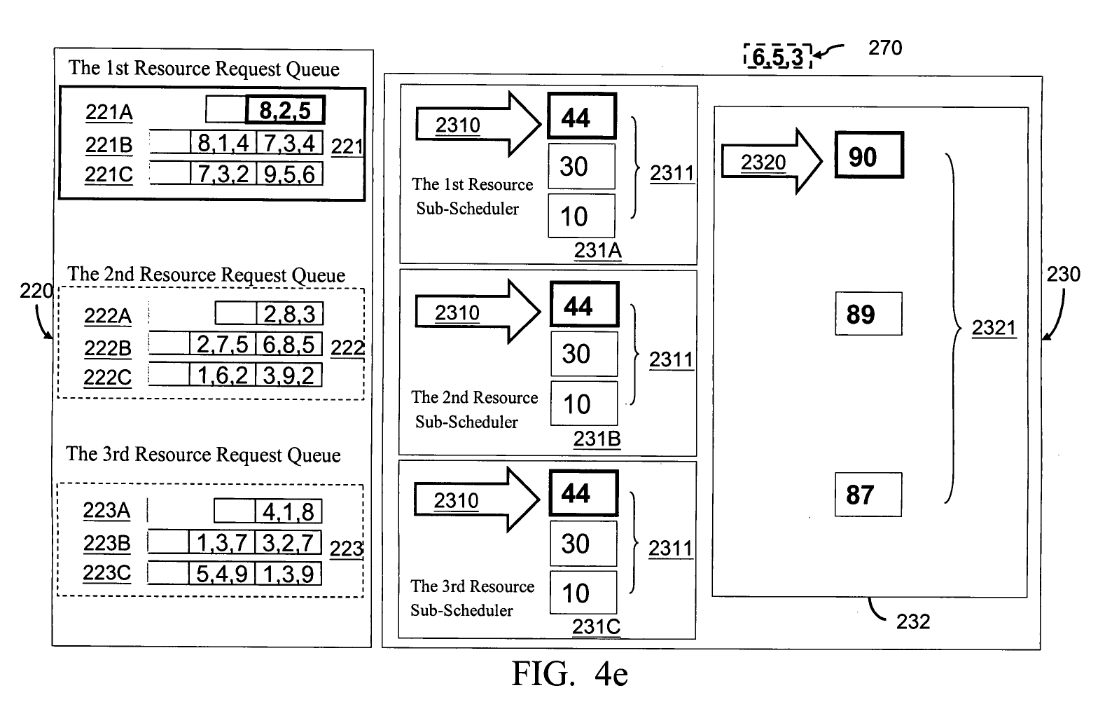

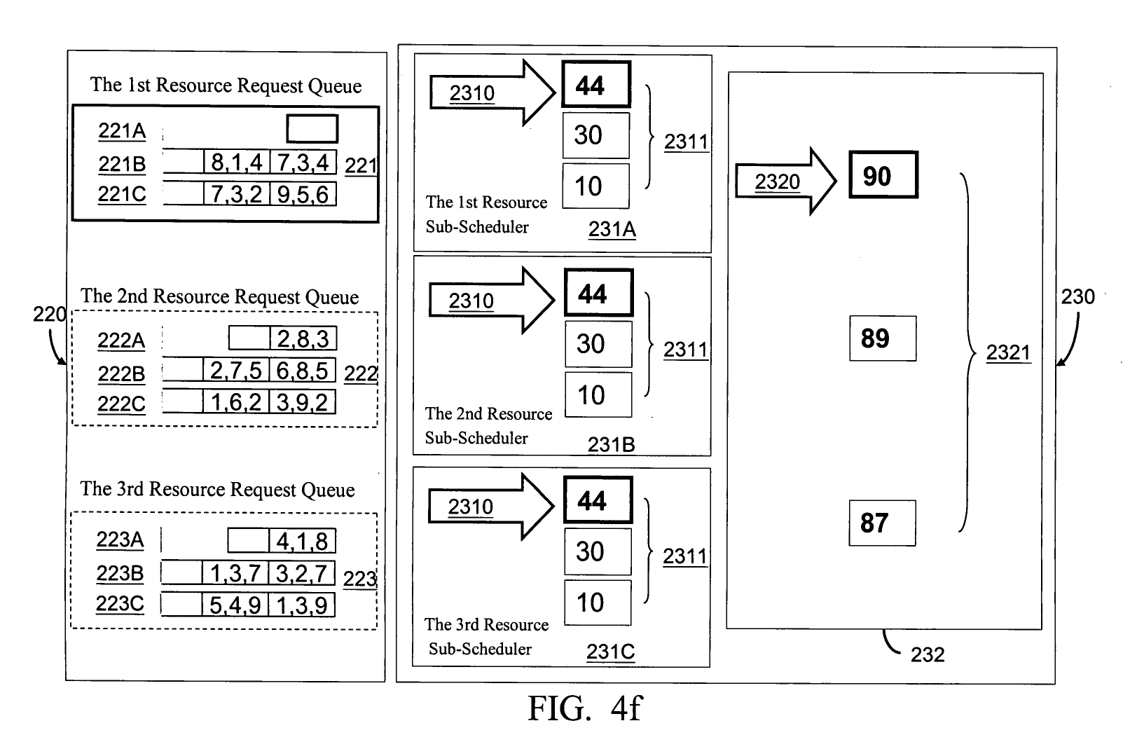

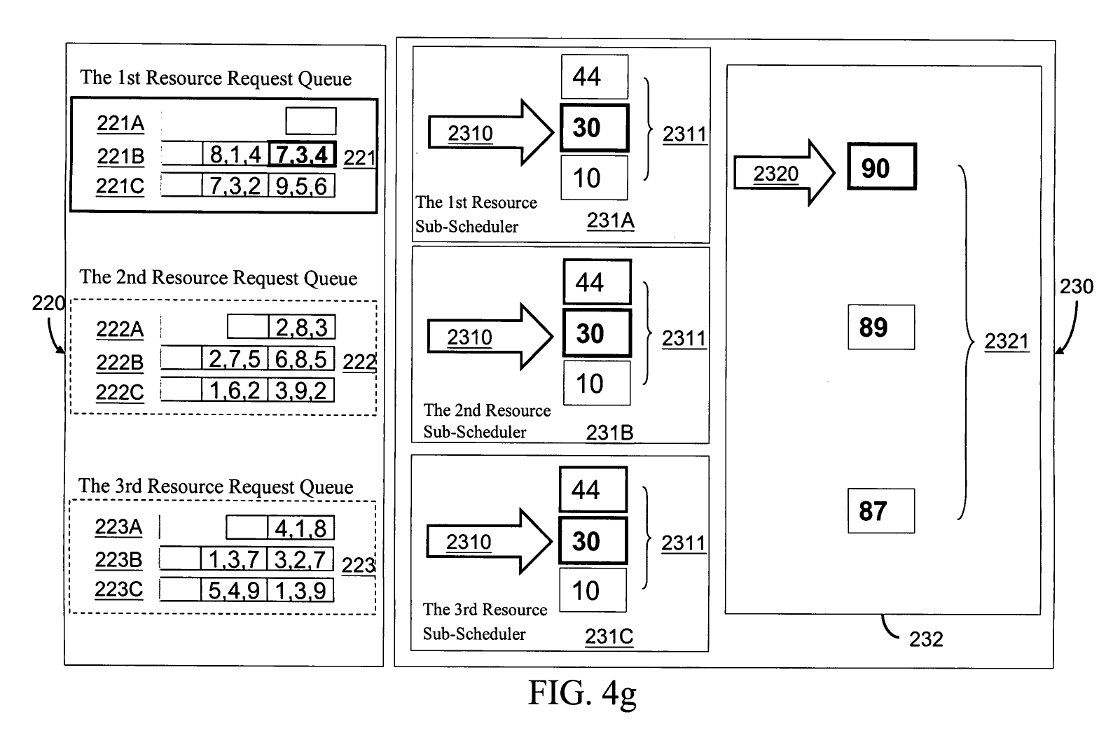

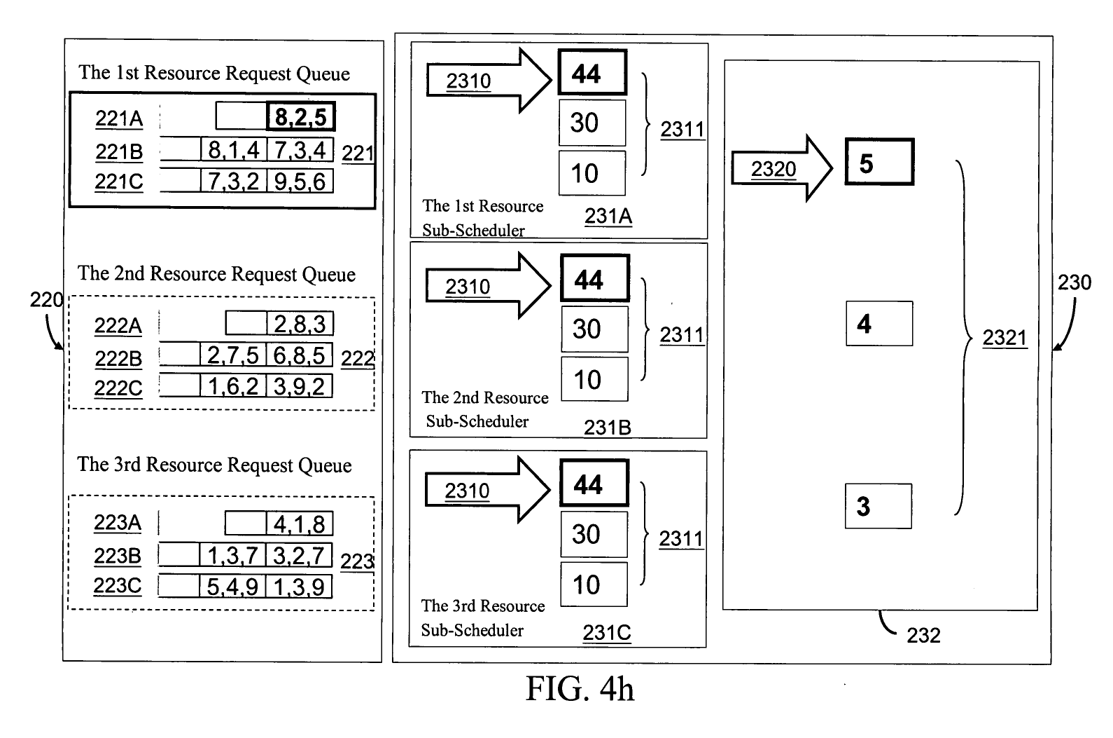

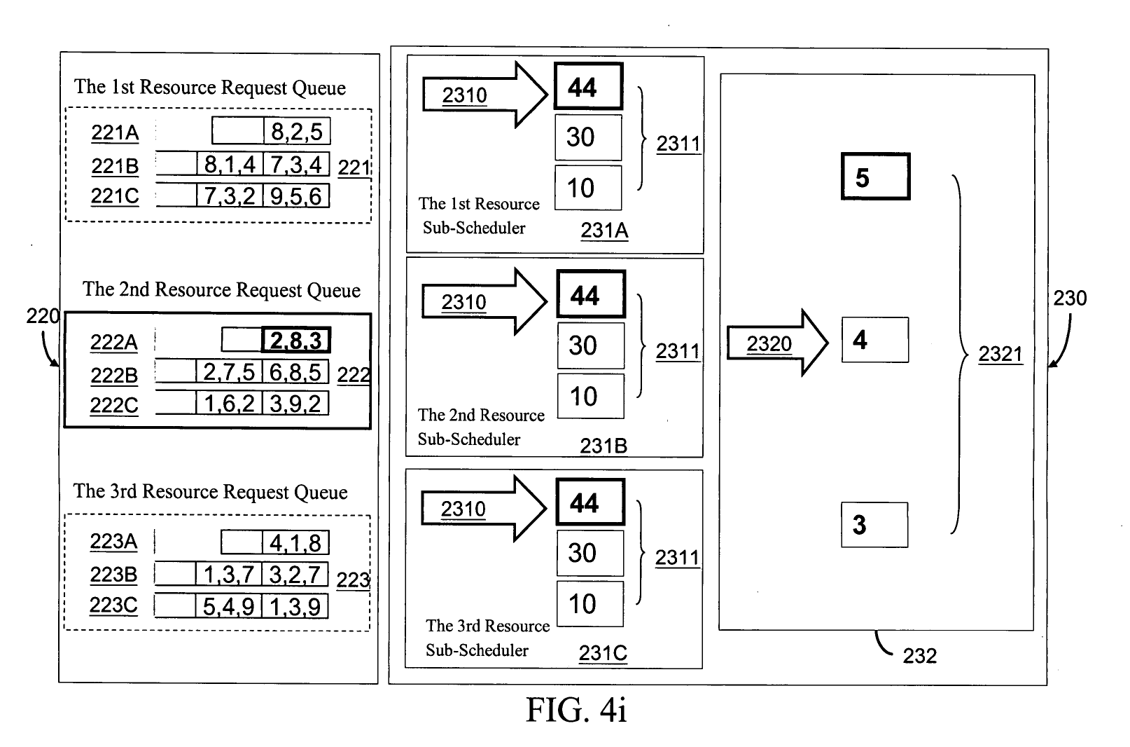

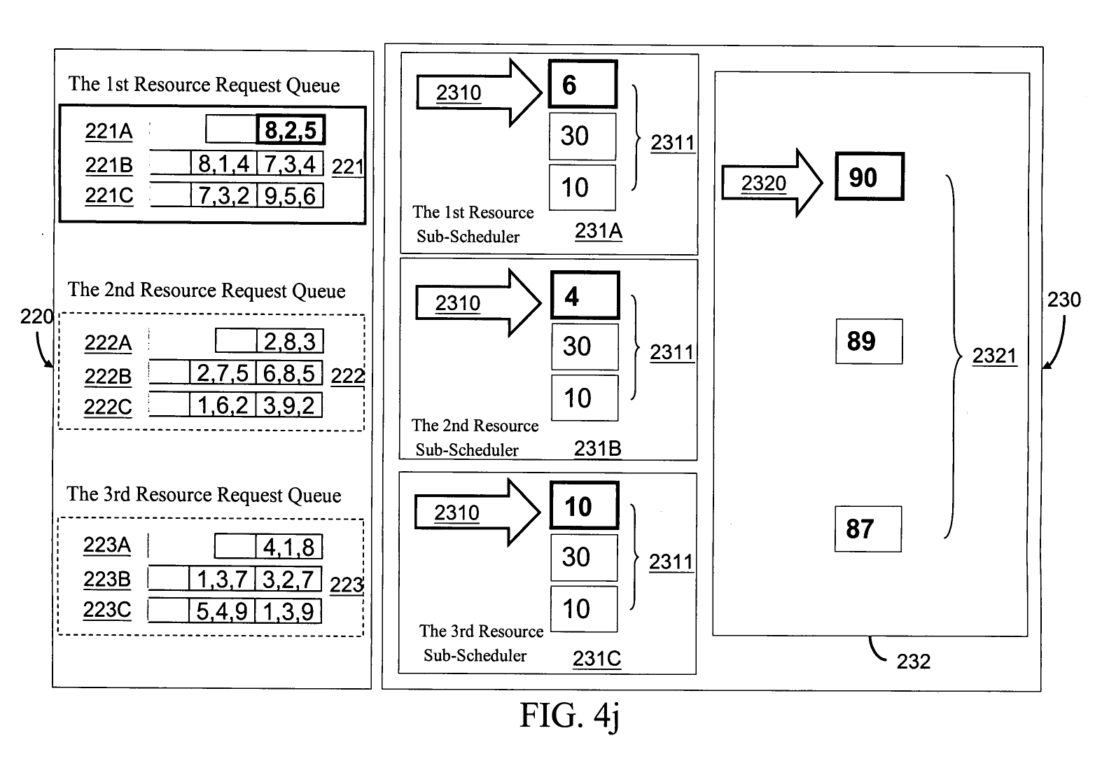

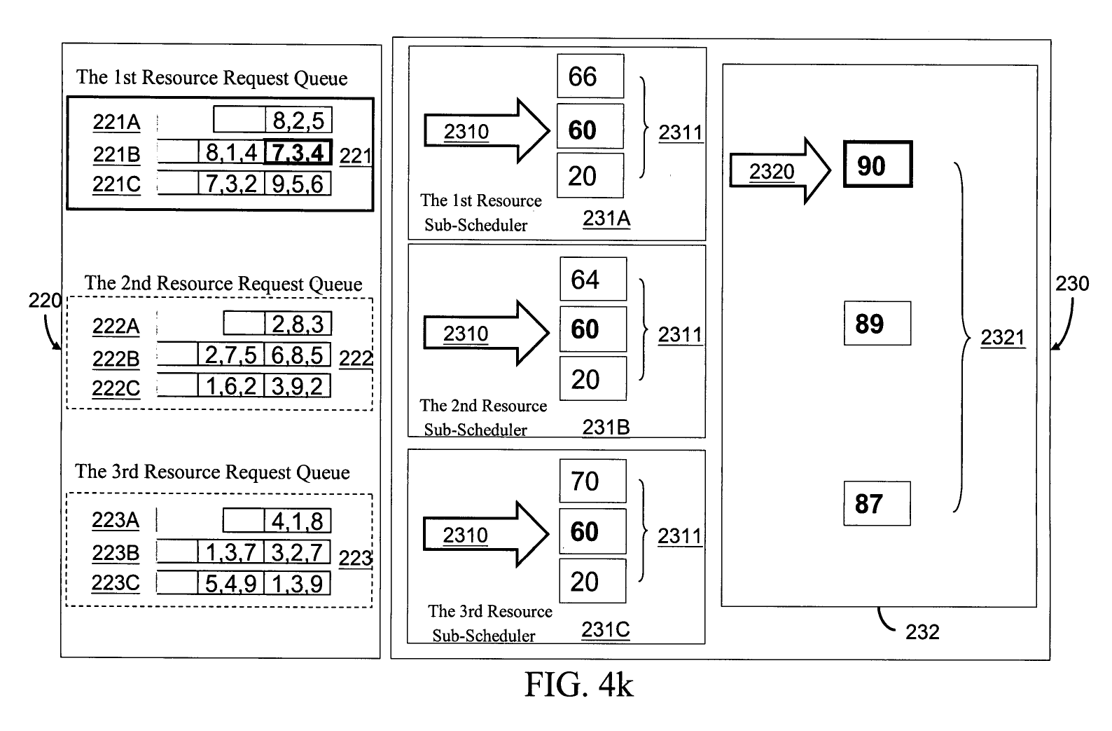

FIG. 2 shows a schematic and functional block diagram of the system operation of the system for providing differentiated service by using category/resource scheduling of the present invention. Generally, the operation mode is executed between the external requests 50 from the Internet 100 and the servo system 150 through the category/resource scheduling differentiated service system 200 of the present invention. The scheduling for processing the external requests 50 enables the servo system 150 to provide service in a differentiated manner. The functional block architecture of the entire category/resource scheduling differentiated service system 200 is as shown herein-below, wherein a part of details of the category/resource scheduling differentiated service system 200 can refer to FIG. 4a together.

(1) Classifier 210. This is mainly used to analyze various external requests 50 submitted from applications of the other end of the Internet 100, and then compare the analyzed result to a service category policy table 250 and a request resource table 260 maintained by an explorer 240. The category classification, resource classification, and resource consumption proportion corresponding to each external request 50 can thus be obtained. Then, the manner how the external requests 50 are registered in request queues 220 is determined according to the information in the service category policy table 250 and the request resource table 260. Typically, the external requests 50 are registered in the category queue corresponding to the category classification in the request queue that is consuming the largest proportion of resources.

(2) Request queues 220. Typically, there is one or more request queues corresponding to different resources of the servo system 150 in the area of the request queues 220, and there are category queues corresponding to different category classifications in each request queue.

Assuming that there are N types of resources in the entire servo system 150, and there are M categories of the external requests 50. Then N request queues, e.g. the 1st resource request queue, . . . , the Nth resource request queue, corresponding to N types of resources of the servo system 150 will be generated in the request queues 220 of the category/resource scheduling differentiated service system 200 according to the present invention, and each request queue further includes M category queues, e.g. category queue 1, . . . , category queue M, corresponding to M categories of external requests 50.

(3) Scheduler 230. It includes one or more sub-schedulers 231 and a main scheduler 232.

The sub-schedulers 231 operate corresponding to the resource counter in the main scheduler 232 and the request queues, e.g. the 1st resource request queue, . . . , the Nth resource request queue, and they are mainly responsible for driving the corresponding sub-scheduler 231 to operate in accordance with the selection result to the resources from the main scheduler 232. Each sub-scheduler 231 has a category counter pointer (as shown in FIG. 4a) and category counters corresponding to the category queues of individual category classifications (e.g., the 1st category queue, . . . , the Mth category queue). Different available category proportions are recorded according to the predetermined category weights of various category classifications in the category counters.

The main scheduler 232 has a resource counter pointer (as shown in FIG. 4a) and one or more resource counters corresponding to different resources of the servo system 150 in operation. The resource counters are used for recording the available resource proportion of each resource.

Similarly, assuming that there are N types of resources in the entire servo system 150, and there are M categories of external requests 50. Then, there are N request queues (i.e. the 1st resource request queue, . . . , the Nth resource request queue), and there are M category queues in each request queue (i.e. the 1st category queue, . . . , the Mth category queue) as described above, therefore there will be N sub-schedulers 231 (i.e. the 1st resource sub-scheduler, . . . , the Nth sub-scheduler) in the scheduler 230 correspondingly, each sub-scheduler comprises M category counters, and there are N resource counters in the main scheduler 232 corresponding to the sub-schedulers 231.

(4) Explorer 240. It is used to pre-establish a situation of the category classification, resource classification, and resource consumption proportion of all external requests 50 that might be received by the servo system 150, and meanwhile calculate the proportion of individual resources of the servo system 150 before the servo system 150 formally starts to process the external requests 50. Once the explorer 240 completes the above data establishment and calculation, the entire category/resource scheduling differentiated service system 200 starts to initialize the request queues 220 and the scheduler 230, which includes generating the category queues of the request queues 220, and the category counters of the sub-schedulers 231 and the resource counters of the main scheduler 232 in the scheduler 230.

Two tables for recording information are generated after the operation of the explorer 240, which will be provided to the classifier 210 to classify the external requests 50 when they are received. One table is the service category policy table 250 for recording the category classification of the external requests 50, wherein the categories of the external requests 50 can be defined according to their content of the network layer or content of the application layer. The other table is the request resource table 260 for recording the proportion of consumed resources of the external requests 50.

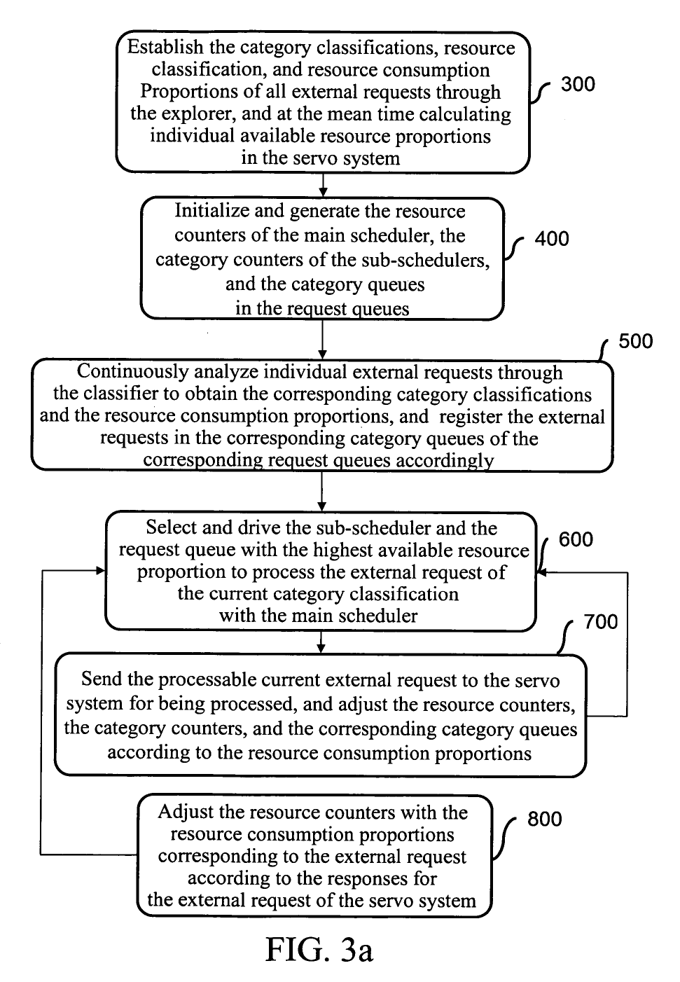

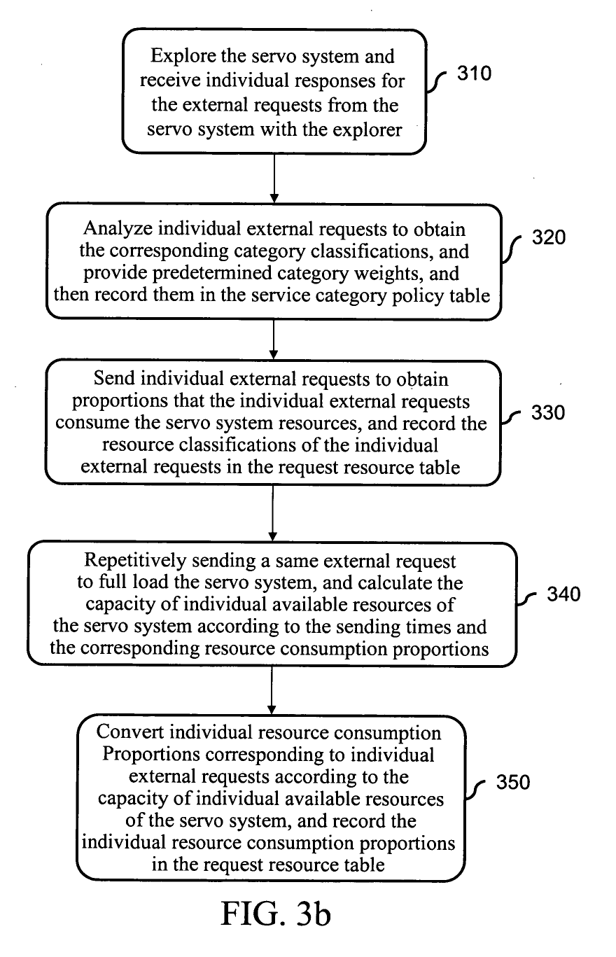

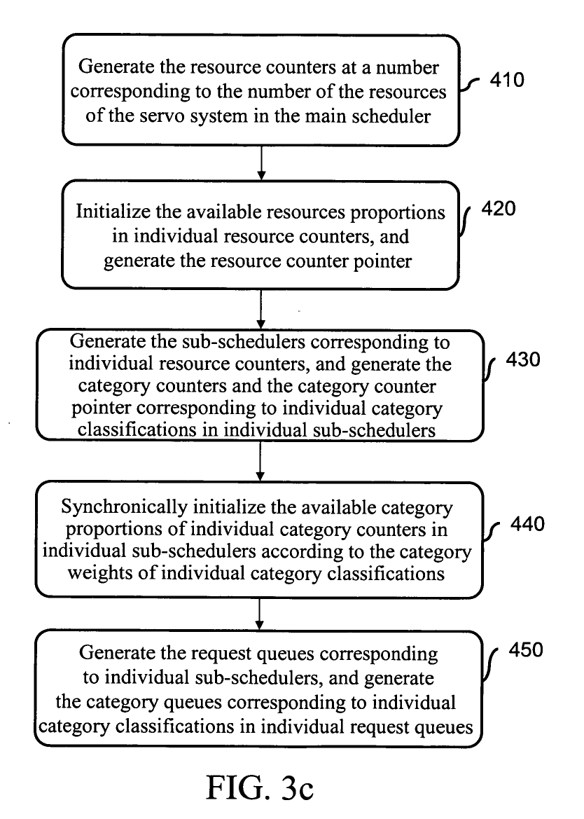

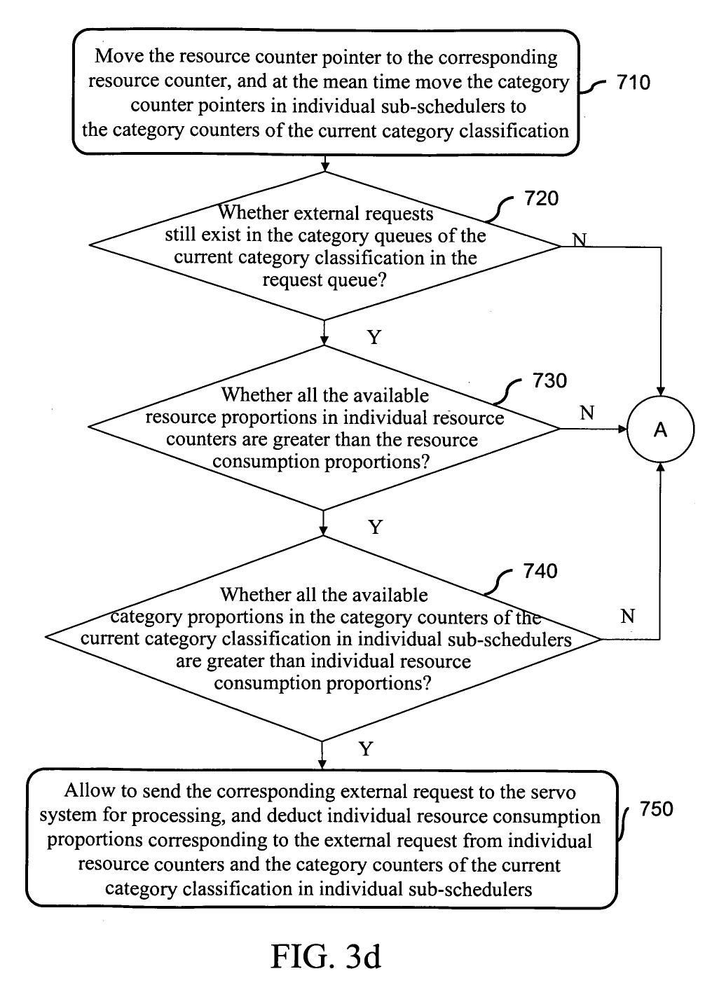

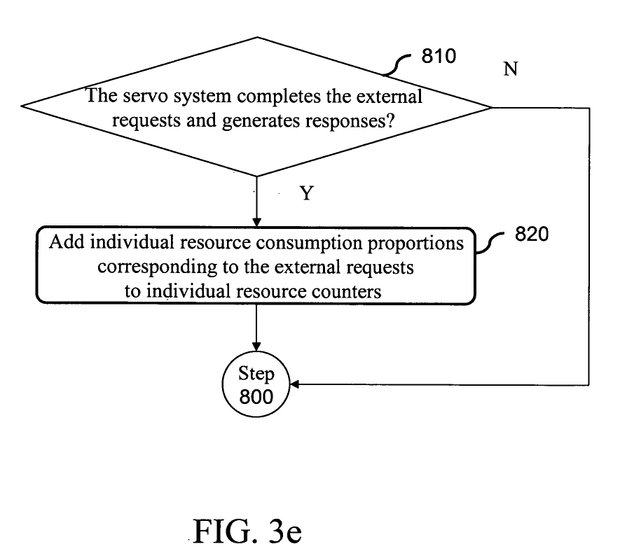

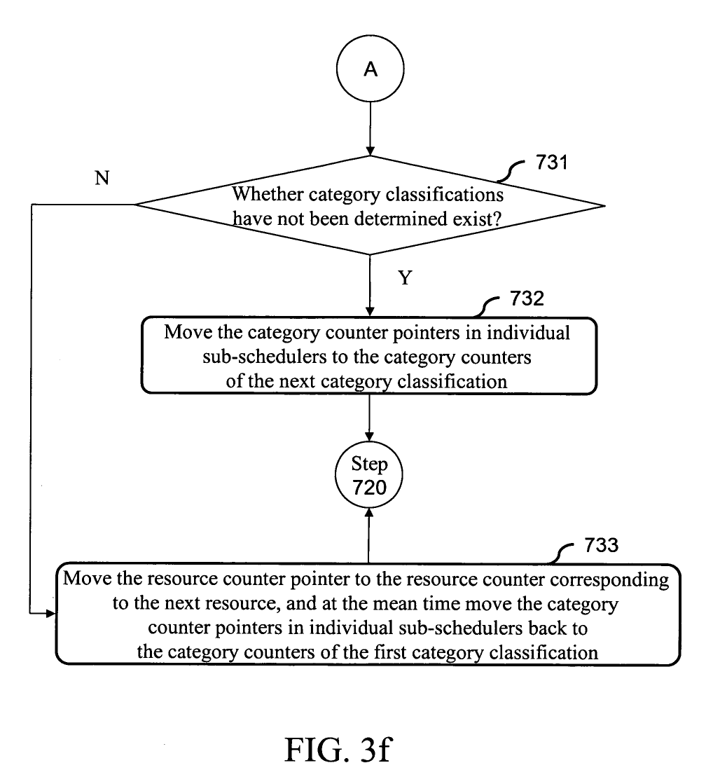

FIGS. 3a to 3f are flow charts of the method for providing differentiated service using category/resource scheduling according to the present invention. The main flow in FIG. 3a will be discussed below.

Before starting to operate, the servo system 150 pre-establishes the category classification, the resource classification, and the resource consumption of all external requests 50 in the servo system 150 through an explorer 240, and calculates the proportion of individual resources of the servo system 150 (Step 300). FIG. 3b is the detailed flow of this step. The explorer 240 initially explores the servo system 150 and receives the responses from individual external requests (Step 310). During the exploration, the explorer 240 first sends an external request 50 to the servo system, 150 to be processed, records the response results from the servo system 150, and then determines whether there are external requests 50 of additional links linked. If yes, the explorer 240 continues to send the corresponding external requests 50 to continue the exploration, and the entire exploration will not be finished until all external requests 50 in the servo system 150 have been explored. After all external requests 50 are retrieved, individual external requests 50 will be analyzed to obtain the corresponding category classification and grant the predetermined category weights to them, and then record them in the service category policy table 250 (Step 320). Then, all external requests 50 are sent to the servo system 150 according to the recorded information, to actually obtain the proportions of resources of the servo system that individual external requests 50 require to consume, and the resource classifications of individual external requests 50 are recorded in the request resource table 260 (Step 330). After the proportion of resources of the servo system consumed by each external request 50 is obtained, the servo system is full loaded by repeatedly sending the same external request 50 to test the capacity of individual resources of the servo system, and then the actual proportions of individual resources of the servo system 150 can be calculated according to the sending times and the resource consumption proportion corresponding to the external request 50 obtained previously (Step 340). Finally, the resource consumption proportions represented by the resource consumption proportions corresponding to individual external requests 50 are converted according to the proportion of individual resources of the servo system 150, and recorded in the request resource table 260 similarly (Step 350).

After completing the above-mentioned operation, the explorer 240 starts the initialization for generating the category queues in the request queues 220, the category counters of the sub-schedulers 231, and the resource counters of the main scheduler 232 in the scheduler 230 (Step 400). The detailed initialization flow refers to the FIG. 3c, which includes the following steps. Generate corresponding number of resource counters according to the number of the types of available resources of the servo system 150 in the main scheduler 232 (Step 410). Then, initialize the available resource proportion of individual resource counters, and generate a resource counter pointer at the same time (Step 420). Generate the sub-schedulers 231 corresponding to individual resource counters in operation (e.g. the 1st resource sub-scheduler, . . . , the Nth resource sub-scheduler mentioned in FIG. 2), and generate category counters corresponding to individual category classifications and a category counter pointer in individual sub-schedulers 231 (Step 430). Synchronically initialize the available category proportions of individual category counters in individual sub-schedulers 231 according to the category weights of individual category classifications (Step 440). The weight proportion of each category can be adjusted according to the practical demands. Finally, generate the request queues corresponding to individual sub-schedulers 231 in the request queues 220 (e.g. the 1st resource request queue, . . . , the Nth resource request queue mentioned in FIG. 2), and generate the category queues corresponding to individual category classifications in each request queue (e.g. category queue 1, . . . , category queue M mentioned in FIG. 2) (Step 450).

After Step 400 is completed, the external requests 50 received from the Internet 100 are continuously analyzed through the classifier 210, then the service category policy table 250 and the request resource table 260 established and maintained by the explorer 240 are referred to know the corresponding category classification and resource consumption proportion corresponding to the current external request 50, and the current external request 50 is registered in the corresponding category queue of the corresponding request queue 220 accordingly (Step 500).

Then, the main scheduler 232 starts to select and drive the sub-scheduler 231 with the highest available resource proportion and the corresponding request queue in the servo system 150 to process the current external request (Step 600). If all the available resource proportions of the servo system 150 are the same at the beginning, the main resource can be randomly selected, and which category of the external requests 50 is to be processed can be selected according to the sequence of the category weights, or may be randomly selected at the beginning. But basically, the selection of resources and category weights is circularly processed with the deficit round robin scheduling algorithm on the whole. After resource category is determined, processable external requests are sent to the servo system 150 to be processed, and the resource counters, the category counters, and the corresponding category queues are adjusted according to the resource consumption proportions of the external requests (Step 700). The detailed flow of Step 700 is further illustrated with FIG. 3d.

Firstly, the resource counter pointer in the main scheduler 232 is moved to the resource counter corresponding to the selected servo system resource, and the category counter pointers in individual sub-scheduler 231 are moved to the category counters of the current category classification (Step 710). Confirm whether the external requests 50 still exist in the category queues of the current category classification in the request queues. (Step 720) If yes, further determine whether the available resource proportions in individual resource counters are greater than the resource consumption proportions. (Step 730) If the available resource proportions are confirmed to be sufficient, further confirm whether all available category proportions of the category counters of the current category classification in individual sub-schedulers are greater than individual resource consumption proportions (Step 740)? If there is no problem after the confirmation in Step 720, Step 730, and Step 740, it indicates that the current external request 50 is allowed to be processed, and the corresponding external request 50 is sent to the servo system 150 to be processed, and individual resource consumption proportions corresponding to the external requests 50 will be deducted from individual resource counters and the category counters of the current category classification of individual sub-schedulers 231 (Step 750).

If any of the Step 720, Step 730, and Step 740 cannot be confirmed, it indicates that the current external request 50 cannot be processed by the servo system 150, and must be adjusted. Therefore, it goes to the flow in FIG. 3f. Firstly, determine whether there are other category classifications have not been determined yet. (Step 731) When other category classifications have not been determined yet still exist, the category counter pointers in individual sub-schedulers are moved to the category counter of a next category classification (Step 732), and then it returns to Step 720 to perform the operation. Otherwise, if no other category classifications have not been determined exist, the resource counter pointer is moved to the resource counter corresponding to the next resource, and meanwhile the category counter pointers in individual sub-schedulers 231 are moved back to the category counters of the first category classification (Step 733), and then it returns to Step 720 to perform the operation.

When the external requests 50 are continuously sent from the Internet 100, the entire category/resource differentiated service system 200 will continuously perform the aforementioned Step 500. And when the external requests 50 have not been processed still exist in the request queues 220, Step 600 and Step 700 will be performed repeatedly in a manner of round cycle. Every time a cycle of Step 600 and Step 700 is completed, it represents that an external request 50 is processed, that is, only one external request 50 is processed at a time. In addition, after all category classifications in the request queues are cycled once, a new round of cycle will begin, and the available category proportions corresponding to the category weights must be added to individual category counters 2311 in accordance with the predetermined category weights of individual category classifications.

It should be noted that after the servo system 150 completes the processing of the external requests 50, it typically generates a corresponding response to indicate that the process is finished, and represent that some resources will be released to be available. Therefore, the major flow of the entire FIG. 3a also includes when the servo system completes the processing of the external requests 50 and generates a response, the resource counters will be adjusted according to the resource consumption proportions corresponding to the external requests 50 (step 800).

Referring to the detailed flow in FIG. 3e, determine whether a response to the completion of the external requests 50 is returned from the end of the servo system 150. (Step 810) If no, remain to wait for the response from the servo system 150. Otherwise, if there is a response from the servo system 150, the main scheduler 232 will add the individual resource consumption proportions corresponding to the external requests 50 into individual resource counters (Step 820), so as to ensure that the servo system 150 maintains the most recent and correct available resource proportions.

FIGS. 4a to 4k show an embodiment of the present invention, wherein the aforementioned operation procedures of Step 300 to Step 500 are omitted, and the embodiment is illustrated only directed to how to process the external requests 50 by the category/resource scheduling differentiated service system 200 of the present invention.

FIG. 4a shows the state that the initialization of the category/resource scheduling differentiated service system 200 of the present invention is completed. It can be seen from the number of the resource counters 2321 of the main scheduler 232 shown in the drawing, there are three types of resources in the servo system 150 of the present embodiment, and after the initialization, the available resource proportions of all resource counters 2321 are set to 100. The external requests are predetermined to be classified into three categories, wherein the predetermined category weights are as following in sequence: the first category weight is 6, the second category weight is 3, and the third category weight is 1. Therefore, after the initialization is completed, there are three request queues in the request queues, namely the first resource request queue 221, the second resource request queue 222, and the third resource request queue 223, each of the individual request queues includes three category queues, namely the first category queues 221A, 222A, and 223A, the second category queues 221B, 222B, and 223B, and the third category queues 221C, 222C, and 223C. The resource request queues 221, 222, and 223 correspond to three sub-schedulers 231, namely the first resource sub-scheduler 231A, the second resource sub-scheduler 231B, and the third resource sub-scheduler 231C respectively. Each of the sub-schedulers 231A, 231B, and 231C has a category counter pointer 2310, and category counters 2311 corresponding to three request queues, wherein the available category proportions granted to the first category, the second category, and the third category are 60, 30 and 10 in sequence according to the relationship of category weights. The main scheduler 232 has a resource counter pointer 2320 and three resources counters 2321 corresponding to different. resources in the servo system 150.

As all proportions of available resources are the same (all are 100), the category/resource scheduling differentiated service system 200 randomly selects a first resource as a start, and the category selection is started from the first category, and in this embodiment it is started from the first category queue 221A. The resource counter pointer 2320 points to the resource counter 2321 corresponding to the first resource proportion, and the first resource sub-scheduler 231A representing the first resource will be driven. Meanwhile, the category counter pointers 2310 in all sub-schedulers 231A, 231B, and 231C will point to the category counters 2311 of the first category, then the external request 50 registered at the very beginning of the first category queue 221A in the first resource request queue 221 is ready to be processed, and the resource consumption proportions that this external request 50 consumes the first resource, the second resource, and the third resource are (6, 5, 3) respectively.

At this time, after the confirmation in Step 720 to Step 740, the external request 50 is allowed to be sent to the servo system 150 to be processed, the state of the entire category/resource scheduling differentiated service system 200 will be as shown in FIG. 4b after the external request 50 is sent. The first external request 50 in the first category queue 221A in the first resource request queue 221 has been retrieved from the registration request queue and sent to the servo system 150, therefore, the first resource proportion, the second resource proportion, and the third resource proportion of all resource counters 2321 in the main scheduler 232 will deduct the resource consumption proportions (6, 5, 3) of the external request 50 being processed, and will become 94, 95, and 97 respectively. And the category counters 2311 of all sub-schedulers 231A, 231B, and 231C will deduct the corresponding resource consumption proportions (6, 5, 3), and will become 54, 55, and 57 respectively. At this time, as the third resource proportion 97 is the highest, the resource counter pointer 2320 will point to the position of the resource counter 2321 of the third resource proportion, and meanwhile, the third resource sub-scheduler 231C is driven to be ready to process the first external request 50 of the first category queue 223A in the third resource request queue 223, wherein the resource consumption proportions are (7, 6, 9) respectively. Similarly, after the confirmation in Step 720 to Step 740, the current external request 50 is also sent to the servo system 150 to be processed.

Like the processing principle described above, the situation after the current external request 50 is sent to the servo system 150 is as shown in FIG. 4c, wherein the resource counters 2321 in the main scheduler 232 are updated to 87, 89, and 88, and the category counters 2311 in all sub-schedulers are updated to 47, 49, and 48. Then, as the available category proportion 89 of the resource counter 2321 belonging to the second resource proportion is the highest, the resource counter pointer 2320 will point to the resource counter representing the second resource proportion. Then the second resource sub-scheduler 231B is driven to get ready to process the first external request 50 of the first category queue 222A in the second resource request queue 222. Similarly, the external request 50 is also sent to the servo system 150 to be processed, to form the situation as shown in FIG. 4d.

But a situation occurs in FIG. 4d in which the three resource proportions are all 84, and the original principle cannot make the selection. At this time, the selection is made randomly. Assuming that the first resource is to be processed after the random selection, in FIG. 4e, operation will be made according to the operation mode of FIG. 4a to FIG. 4c. But we can see in FIG. 4e that the servo system 150 has completed the process of the earliest external request 50 and has generated a response. At this time, in the category/resource scheduling differentiated service system 200, the resource consumption proportions (6, 5, 3)270 of the response corresponding to the external request will be added to the resource counters 2321 corresponding to individual resource proportions, and the available resource proportions in individual resource counters 2321 will be increased by 6, 5, and 3 and be updated to 96, 94, and 90 respectively.

FIG. 4f and 4g provide another processing mechanism of the category/resource scheduling differentiated service system 200 according to the present invention. The situation is as shown in FIG. 4f, when there is no external request 50 to be processed in the first category queue 221A that is ready to be processed, skip to the next category classification to continue the process. As shown in FIG. 4g, all category counter pointers 2310 will move to the positions of the category counters 2311 of the second category classification to get ready to process the earliest external request 50 in the second category queue 221B of the first resource request queue 221, and the resource consumption proportion required by the external request 50 is (7, 3, 4).

FIG. 4h and FIG. 4i are situations when the available resource proportions remained in individual resource counters 2321 are less than the resource consumption proportions required by the current external request 50. For example, in FIG. 4h, the first resource proportion is 5, which is less than 8 required by the current external request 50 ready to be processed, so the processing mechanism in FIG. 4h will be referred to, and it skips to the next category to determine whether the process can be done. As shown in FIG. 4i, if all categories are unavailable, it skips to the next resource to perform the process.

FIG. 4j and FIG. 4k are situations when the available resource proportions remained in the category counters 2311 of the current category in the sub-schedulers 231A, 231B, and 231C are less than the resource consumption proportions required by the current external request 50. As shown in FIG. 4j, the category counter 2311 representing the first category proportion in the first resource scheduler 231A is 6, which is less than 8 required by the current external request 50 ready to be processed, so the processing mechanism of FIG. 4f will be referred to, and it skips to the next category to determine whether the process can be done. If all categories are unavailable, it represents that this round of scheduling cycle is completed, and all category counter pointers will again point to the first category counter at this time. As shown in FIG. 4k, proportions 60, 30, and 10 of the original available categories will be added to the values remained in each category counter. It should be noted that the maximum value of each category counter is 100, and if the values with proportions added exceed 100, the values must still be calculated as 100, since one category cannot use more that 100 percent of a certain resource in the servo system.

The foregoing description is the technical content of the system for providing differentiated service using category/resource scheduling and the method therefor. The present invention is completely realized through computer executable programs, so it can be optionally executed on servers including servo systems directly, or be executed at Internet relay points on the Internet path through which the external requests 50 are sent to the servo system 150. Possible Internet relay points include gateways, routers, proxy servers, load-balanced servers, and the like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for providing differentiated service by using category/resource scheduling, which is applicable for scheduling external requests by utilizing computer executable programs, according to the category classifications, resource categories, and resource consumption proportions, and the available resource proportions of various sources in a servo system, to provide differentiated service when the servo system receives the external requests from the Internet, comprising:
a scheduler, including a main scheduler and one or more sub-schedulers, wherein:
the main scheduler has a resource counter pointer and one or more resource counters corresponding to the number of the resources of the servo system; and
the one or more sub-schedulers correspond to various resource counters, and each of the sub-schedulers has a category counter pointer and category counters corresponding to various category classifications; and
one or more request queues, corresponding to individual sub-schedulers, and each of the request queues has category queues corresponding to individual category classifications;
wherein when there are external requests in the request queues have not been processed yet, the main scheduler selects and drives the sub-scheduler and the request queue with the highest available resource proportion to process the external request of the current category classification, sends processable current external request to the servo system to be processed, and adjusts the resource counters, the category counters, and the corresponding category queues according to the resource consumption proportion, and repeatedly performs this procedure in round cycles.

2. The system for providing differentiated service by using category/resource scheduling as claimed in claim 1, wherein the system further comprises an explorer for pre-establishing category classifications, resource classifications, and resource consumption proportions of all external requests, and in the meantime calculating individual available resource proportions of the servo system, after the explorer completes the establishment and the calculation, the system initializes and generates the resource counters in the main scheduler, the category counters in the sub-schedulers, and the category queues of the request queues.

3. The system for providing differentiated service by using category/resource scheduling as claimed in claim 1, wherein the system further comprises a classifier for analyzing individual external requests to obtain corresponding category classifications and resource consumption proportions, and registering the external requests in the corresponding category queues in the corresponding request queues accordingly.

4. The system for providing differentiated service by using category/resource scheduling as claimed in claim 1, wherein the system further comprises adding individual resource consumption proportions corresponding to the external requests to individual resource counters according to the resource consumption proportions corresponding to the external requests, when the servo system completes the process of the external requests and generates responses.

5. The system for providing differentiated service by using category/resource scheduling as claimed in claim 1, wherein the category counter pointer is circularly moved with a deficit round robin scheduling algorithm.

6. The system for providing differentiated service by using category/resource scheduling as claimed in claim 1, wherein the system registers the external requests in the category queues corresponding to the category classifications in the request queue of resource with the highest resource consumption proportion.

7. The system for providing differentiated service by using category/resource scheduling as claimed in claim 1, wherein the system processes only one external request at a time.

8. The system for providing differentiated service by using category/resource scheduling as claimed in claim 2, wherein the explorer further comprises:
a service category policy table for recording the category classifications of the external requests; and
a request resource table for recording the resource consumption proportions of the external requests.

9. The system for providing differentiated service by using category/resource scheduling as claimed in claim 3, wherein the classifier determines the category classifications by analyzing a network layer content of the external requests.

10. The system for providing differentiated service by using category/resource scheduling as claimed in claim 3, wherein the classifier determines the category classifications by analyzing an application layer content of the external requests.

11. The system for providing differentiated service by using category/resource scheduling as claimed in claim 1, wherein the system is executed at Internet nodes linked to the servo system.

12. The system for providing differentiated service by using category/resource scheduling as claimed in claim 11, wherein the Internet node is a gateway, a router, a proxy server, or a load-balanced server.

13. A method for providing differentiated service by using category/resource scheduling, which is applicable for scheduling external requests by utilizing computer executable programs, according to the category classifications, resource categories, and resource consumption proportions, and the available resource proportions of various sources in a servo system, to provide differentiated service when the servo system receives the external requests from the Internet, comprising: p1 (a) initializing and generating the resource counters of a main scheduler, the category counters of sub-schedulers, and the category queues of a request queue;
(b) selecting and driving the sub-scheduler and the request queue with the highest available resource proportion to process the external request of the current category classification; and
(c) sending the processable current external request to the servo system to be processed, adjusting the resource counters, the category counters, and the corresponding category queues according to the resource consumption proportions;
wherein when there are external request have not been processed yet, Step (b) and Step (c) are performed in a round cycle.

14. The method for providing differentiated service by using category/resource scheduling as claimed in claim 13, where in the Step (a) further comprises:
generating the resource counters at a number corresponding to the number of the resources of the servo system in the main scheduler;
initializing the available resources proportions in individual resource counters, and generating a resource counter pointer;
generating the sub-schedulers corresponding to individual resource counters, and generating the category counters and category counter pointers corresponding to individual category classifications in individual sub-schedulers;
synchronically initializing the available category proportions of individual category counters in individual sub-schedulers according to the category weights of individual category classifications; and
generating the request queues corresponding to individual sub-schedulers, and generating the category queues corresponding to individual category classifications in individual request queues.

15. The method for providing differentiated service by using category/resource scheduling as claimed in claim 14, wherein the category counter pointer is circularly moved with a deficit round robin scheduling algorithm.

16. The method for providing differentiated service by using category/resource scheduling as claimed in claim 13, wherein the Step (b) processes only one external request at a time.

17. The method for providing differentiated service by using category/resource scheduling as claimed in claim 13, wherein the Step (c) registers the external requests in the category queues corresponding to category classifications in the request queue of resource with the highest resource consumption proportion.

18. The method for providing differentiated service by using category/resource scheduling as claimed in claim 13, wherein the Step (c) further comprises:
(c-1) moving the resource counter pointer to the corresponding resource counter, and in the meantime moving the category counter pointers in individual sub-schedulers to the category counters of the current category classification;
(c-2) confirming whether external requests still exist in the category queues of the current category classification in the request queue;
(c-3) confirming whether the available resource proportions in individual resource counters are all greater than the resource consumption proportions;
(c-4) confirming whether the available category proportions in the category counters of the current category classification in individual sub-schedulers are all greater than individual resource consumption proportions; and
(c-5) allowing to send the corresponding external requests to the servo system to be processed, and deducting individual resource consumption proportions corresponding to the external requests from individual resource counters and the category counters of the current category classification in individual sub-schedulers.

19. The method for providing differentiated service by using category/resource scheduling as claimed in claim 18, wherein when the answers to Step (c-2), Step (c-3), and Step (c-4) are No, it comprises further performing the following step:
moving the category counter pointers in individual sub-schedulers to the category counters of the next category classification when other category classifications have not been determined to still exist.

20. The method for providing differentiated service by using category/resource scheduling as claimed in claim 18, wherein when the answers to Step (c-2), Step (c-3), and Step (c-4) are No, it further comprises performing the following step:
moving the resource counter pointer to the resource counter corresponding to the next resource, and in the meantime moving the category counter pointers in individual sub-schedulers back to the category counters of the first category classification when no category classifications have not been determined to exist.

21. The method for providing differentiated service by using category/resource scheduling as claimed in claim 13, wherein the method further comprises the Step (d) of pre-establishing the category classifications, resource classification, and resource consumption proportions of all external requests in the servo system through the explorer, and in the meantime calculating individual available resource proportions in the servo system.

22. The method for providing differentiated service by using category/resource scheduling as claimed in claim 21, wherein the Step (d) further comprises:
exploring the servo system and receiving individual responses for the external requests from the servo system with the explorer;
analyzing individual external requests to obtain the corresponding category classifications, and providing predetermined category weights and then recording them in the service category policy table;
sending individual external requests to obtain proportions that the individual external requests consume the servo system resources, and recording the resource classifications of the individual external requests in the request resource table;
full loading the servo system by repeatedly sending a same external request, and calculating the capacity of individual available resources of the servo system according to the sending times and the corresponding resource consumption proportions; and
converting individual resource consumption proportions corresponding to individual external requests according to the capacity of individual available resources of the servo system, and recording the individual resource consumption proportions in the request resource table.

23. The method for providing differentiated service by using category/resource scheduling as claimed in claim 25, wherein the step of analyzing individual external requests to obtain corresponding category classifications mainly refers to determining the category classification by analyzing a network layer content of the external requests.

24. The method for providing differentiated service by using category/resource scheduling as claimed in claim 25, wherein the step of analyzing individual external requests to obtain corresponding category classifications mainly refers to determining the category classification by analyzing an application layer content of the external requests.

25. The method for providing differentiated service by using category/resource scheduling as claimed in claim 16, wherein the method further comprises Step (e) of continuously analyzing individual external requests through the classifier to obtain the corresponding category classifications and the resource consumptions proportions, and registering the external requests in the corresponding category queues of the corresponding request queues accordingly.

26. The method for providing differentiated service by using category/resource scheduling as claimed in claim 28, wherein the Step (e) refers to determining the category classifications according to the comparison with the service category policy table and determining the resource consumption proportions according to the comparison with the request resource table.

27. The method for providing differentiated service by using category/resource scheduling as claimed in claim 16, wherein the method further comprises the step of immediately performing Step (e) when the external requests are generated.

28. The method for providing differentiated service by using category/resource scheduling as claimed in claim 16, wherein the method further comprises Step (f) of adjusting the resource counters according to the resource consumption proportions corresponding to the external requests when the servo system completes the processes of the external requests and generates responses.

29. The method for providing differentiated service by using category/resource scheduling as claimed in claim 26, wherein the Step (f) further comprises:
determining whether or not the servo system has completed the processes of the external requests and generated responses; and
adding individual resource consumption proportions corresponding to the external requests to individual resource counters.

30. The method for providing differentiated service by using category/resource scheduling as claimed in claim 16, wherein the method regards a situation that all category classifications have completed the process for an external request as a round cycle, and the method further comprises the step of adding corresponding available category proportions to individual category counters in individual sub-schedulers according to the category weights of individual category classifications every time a new round cycle is started.
